(19) United States
(12) Patent Application Publication
(10) Pub. No.: US 2020/0031370 A1
(43) Pub. Date: Jan. 30, 2020

(54) Driver Behavior Based Propulsion Control Strategy Using Artificial Intelligence

(71) Applicant: Continental Powertrain USA, LLC, Auburn Hills, MI (US)

(72) Inventor: Ihab Soliman, Washington, MI (US)

(73) Assignee: Continental Powertrain USA, LLC, Auburn Hills, MI (US)

(21) Appl. No.: 16/521,330

(22) Filed: Jul. 24, 2019

Related U.S. Application Data
(60) Provisional application No. 62/703,254, filed on Jul. 25, 2018.
(60) Provisional application No. 62/703,262, filed on Jul. 25, 2018.
(60) Provisional application No. 62/721,926, filed on Aug. 23, 2018.

(51) Int. Cl. B60W 50/14; G06N 20/00; G05D 1/00; B60W 30/18; B60W 10/04; B60W 40/09

(52) U.S. Cl. CPC B60W 50/14; G06N 20/00; G05D 1/0088; B60W 30/18; B60W 2600/00; B60W 40/09; B60W 2550/22; B60W 2550/12; B60W 2050/146; B60W 10/04

(57) ABSTRACT

A method of adjusting a propulsion system of a vehicle in real time is provided. The method includes receiving one or more direct driver inputs from a vehicle control system and receiving sensor data from a vehicle sensor system. The method also includes determining a predicted driver behavior based on the direct driver inputs and the sensor data. The method also includes determining a propulsion adjustment based on the predicted driver behavior. The method includes sending to the propulsion system in communication with the data processing hardware, instructions to modify one or more parameters of the propulsion system based on the propulsion adjustment.

### CROSS REFERENCE TO RELATED APPLICATIONS

This U.S. patent application claims priority under 35 U.S.C. § 119(e) to U.S. Provisional Application 62/703,254, filed on Jul. 25, 2018, U.S. Provisional Application 62/703,262, filed on Jul. 25, 2018, and U.S. Provisional Application 62/721,926, filed on Aug. 23, 2018. The disclosures of these prior applications are considered part of the disclosure of this application and are hereby incorporated by reference in their entireties.

### TECHNICAL FIELD

This disclosure relates to a method and system for learning driver behavior using artificial intelligence and based on the learned data (algorithm), coaching the driver to improve vehicle efficiency, or adjusting a propulsion system to improve vehicle efficiency.

### BACKGROUND

A vehicle propulsion system includes a source of mechanical power, i.e., engine or electric motor, and a mechanism that transfers this power to generate tractive force, i.e., wheels and axles. The propulsion system drives the vehicle in a forward/rearward direction.

Recent advancements in sensor technology and processing capacity have led to improved safety for vehicles and to the capability of controlling vehicle propulsion systems. Referring to FIG. 1, in some examples, a vehicle 10 includes a propulsion system 14 being part of the vehicle's powertrain 12. The vehicle 10 includes a propulsion system controller 16 which controls the propulsion system 14 to drive the vehicle 10. The propulsion system controller 14 outputs control commands to the powertrain 12 (i.e., the propulsion system 14), which ultimately drives the vehicle 10. The propulsion system controller 16 receives sensor data 19, 21 from sensors 18, 20 supported by the vehicle 10. The sensor data 19, 21 may include vehicle sensor data 19 and environment sensor data 21. The vehicle sensor data 19 may include, but is not limited to, battery current, voltage, state-of-charge, traction drive motor torque, motor speed, motor current, temperature, driveline component torques, gear ratio, vehicle lateral and longitudinal acceleration/deceleration, steering angle, wheel speeds, etc. The environment sensor data 21 may include, but is not limited to, vehicle speed and road speed limit, route profile (e.g., three-dimensional route profile), traffic light crossings and locations, weather conditions, dynamic traffic, surrounding vehicle information via LIDAR or radars. The propulsion system controller 16 receives the sensor data 19, 21 and the driver pedal and steering inputs 11 (i.e., accelerator pedals, brake pedals, and steering angle) and adjusts the propulsion system 14 controlled by the propulsion system controller 16. Therefore, the propulsion control is reactive since it adjusts the propulsion system 14 based on the inputs the propulsion system controller 16 receives. In addition, the current system shown in FIG. 1 includes complex calibrations that consider the average driver (or a range of drivers) and a wide range of operating conditions. The performance goal of the system is to provide consistent operation, i.e., propulsion system adjustment, over the life of the vehicle 10. This means that the propulsion system controller 16 does not tailor the adjustments to the propulsion system 14 based on each unique driver 30. In some examples, the propulsion system controller 16 may make limited adjustments to the propulsion system 14 based on the vehicle environment such as if the vehicle 10 is driving on road with changing road grades and elevation (e.g., uphill versus downhill, high altitude) grades (e.g., transmission gear shift scheduling adjustment or engine combustion and torque control adaptation). Thus, the system provides limited control adjustment to a dynamic driving environment. Moreover, as shown, the driver 30 does not get any feedback when the propulsion system 14 is adjusted; the only feedback is the vehicle response (i.e. acceleration, deceleration, etc.).

Therefore, it is desirable to provide a system that is anticipatory versus the previous reactive system to adjusting the propulsion system. In other words, it is desirable to have a system that considers multiple inputs and determines that an adjustment in the propulsion system is necessary based on the received inputs.

### SUMMARY

One aspect of the disclosure provides a method of adjusting a propulsion system of a vehicle in real time. The method includes receiving, at data processing hardware, one or more direct driver inputs from a vehicle control system in communication with the data processing hardware. The method also includes receiving, at the data processing hardware, sensor data from a vehicle sensor system in communication with the data processing hardware. The sensor data may include vehicle sensor data and environment sensor data. In some examples, the vehicle sensor data includes at least one of battery sensor data, traction drive motor sensor data, and driveline component sensor data. The environment sensor data may include at least one of vehicle speed data, road speed limit data, route profile data, traffic light crossings data and their respective location data, weather conditions data, and dynamic traffic data. The method also includes determining, at the data processing hardware, a predicted driver behavior based on the direct driver inputs and the sensor data and a propulsion adjustment based on the predicted driver behavior. The method also includes sending, from the data processing hardware to the propulsion system in communication with the data processing hardware, instructions to modify one or more parameters of the propulsion system based on the propulsion adjustment.

Implementations of the disclosure may include one or more of the following optional features. In some implementations, the method further includes determining an ideal driver behavior based on the direct driver inputs and the sensor data. The propulsion adjustment may be based on a difference between the predicted driver behavior and the ideal driver behavior.

In some implementations, the instructions include sending visual instructions to a user interface in communication with the data processing hardware. The visual instructions cause the user interface to display a message that includes the modification of the one or more parameters of the propulsion system. Additionally or alternatively, the instruction may include audible instructions to a voice system in communication with the data processing hardware. The audible instructions cause a voice system to output an audible message or a chime indicative of the modification of the one or more parameters of the propulsion system.

In some implementations, during a learning phase, the method includes receiving learning direct driver inputs from the vehicle control system and receiving learning sensor data from the vehicle sensor system. In addition, during the learning phase, the method includes associating one or more driver actions with the learning direct driver inputs and the learning sensor data. The one or more driver actions indicative of an action taken by a driver of the vehicle to control the vehicle in response to the learning direct driver inputs and the learning sensor data. Also during the learning phase, the method includes storing the one or more associated driver actions with the learning direct driver inputs and the learning sensor data as one or more stored driver behaviors in memory hardware. In some examples, determining the predicted driver behavior includes: retrieving, from the memory hardware in communication with the data processing hardware, a stored driver behavior from the one or more stored driver behaviors. The stored driver behavior associated with learning direct driver inputs and learning sensor data being similar to the received one or more direct driver inputs and the received sensor data respectively.

Another aspect of the disclosure provides a system for adjusting a propulsion system of a vehicle in real time. The system includes: data processing hardware; and memory hardware in communication with the data processing hardware. The memory hardware stores instructions that when executed on the data processing hardware cause the data processing hardware to perform operations that include the method described according to the first aspect of the disclosure.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of vehicle including a prior art propulsion system controller.

FIGS. 2 and 3 are schematic views of a vehicle that includes an exemplary vehicle control and energy efficiency system with driver coaching.

FIG. 4 is a schematic view of an exemplary arrangement of operations for providing driver behavior suggestion to improve vehicle efficiency and/or performance.

FIGS. 5 and 6 are schematic views of a vehicle that includes an exemplary efficiency system with propulsion control adaptation.

FIG. 7 is a schematic view of a vehicle that includes an exemplary efficiency system with artificial intelligence-based propulsion control adaptation and driver coaching.

FIGS. 8 and 9 are schematic views of a vehicle that includes an exemplary efficiency system with propulsion control adaptation based on driver behavior.

FIG. 10 is a schematic view of an exemplary arrangement of operations for adjusting the propulsion system to improve vehicle efficiency and/or performance.

FIGS. 11 and 12 are schematic views of a vehicle that includes an exemplary efficiency system, autonomous system, and a drive system.

FIG. 13 is a schematic view of a vehicle that includes an exemplary efficiency system with propulsion control adaptation based on driver behavior.

FIG. 14 is a schematic view of an exemplary arrangement of operations for propulsion efficient autonomously driving a vehicle.

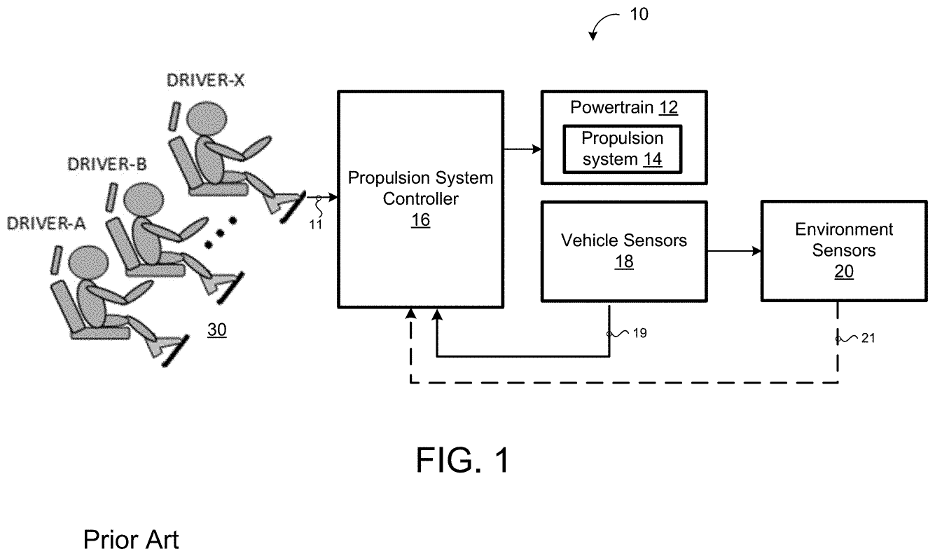

Like reference symbols in the various drawings indicate like elements.

### DETAILED DESCRIPTION

A vehicle, such as, but not limited to a car, a crossover, a truck, a van, a sports-utility-vehicle (SUV), and a recreational vehicle (RV) may be used for personal driving or commercial driving (deliveries, taxis, etc.). Therefore, a propulsion system associated with each vehicle performs differently based on the vehicle, the use of the vehicle, and sensor data associated with the vehicle and the vehicle environment.

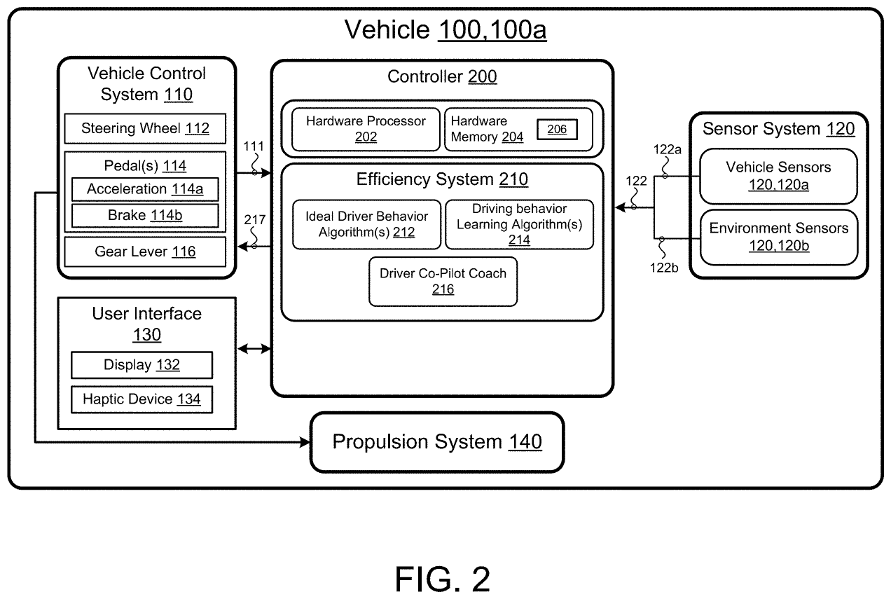

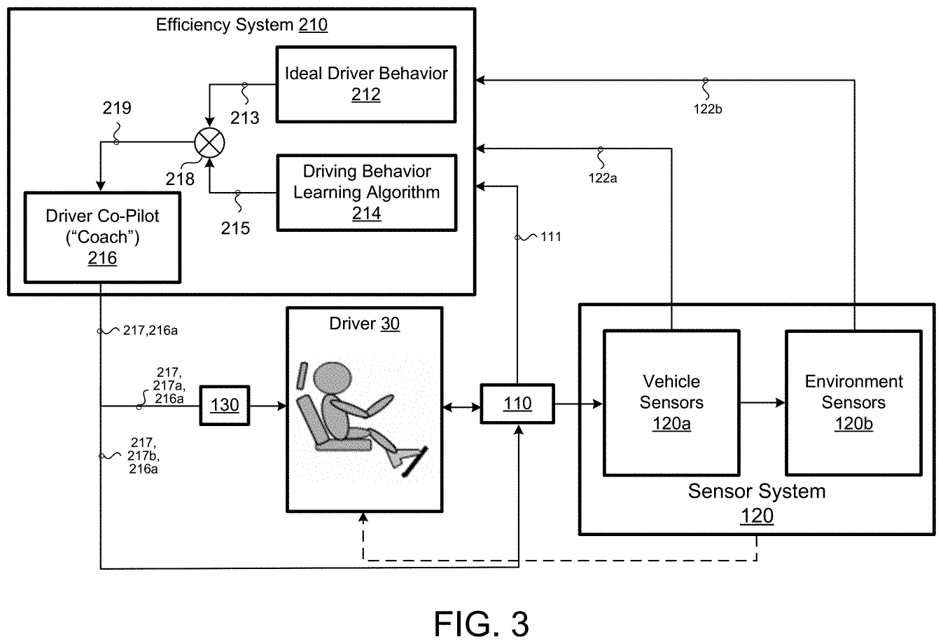

Referring to FIGS. 2 and 3, a vehicle 100, 100a includes a vehicle control system 110 that allows a driver 30 to drive the vehicle 100. The vehicle control system 110 includes a steering wheel 112 that is manipulated by the driver 30 to control the lateral direction of the vehicle 100. The vehicle control system 110 also includes pedals 114, such as, acceleration pedals 114a and brake pedals 114b. The pedals 114 control acceleration and braking of the vehicle 100. The vehicle control system 110 also includes a gear lever 116 for controlling the forward or reverse direction of operation of the vehicle 100, 100a and for securely parking the vehicle 100, 100a via a park position selection. The gear lever 116 also allows for neutral gear selection to allow zero torque at the wheels and vehicle towing. In some examples, the gear lever 116 may directly control a transmission or gearbox to change the speed-torque ratio of the vehicle 100 from the wheels to the engine and/or electric motor drive. In some examples, the gear lever 116 may be a shift by wire system to allow selection of Park, Reverse, Neutral and Drive, other positions may also be included, for example, “B—braking mode, S—sport mode, etc.

The vehicle 100, 100a also includes a sensor system 120 to provide reliable and robust sensor data 122. The sensor system 120 includes different types of sensors. The sensor system 120 may include vehicle sensors 120a that provide vehicle sensor data 122a associated with the vehicle 100, 100a, for example, sensors that are associated with a battery, a traction drive motor, engine, brake system and a driveline component. The sensor system 120 may also include environment sensors 120b that provide environment sensor data 122b that may be used separately or with one another to create a perception of the environment of the vehicle 100, 100a. In addition, the environment sensor data 122b may include, but is not limited to, average vehicle speed affected by surrounding vehicles, road speed limits, route profile (grade, elevation, curvature, three-dimensional profile data, etc.), traffic light crossings and locations, weather conditions, dynamic traffic data. The sensor data 122, i.e., vehicle sensor data 122a and environment sensor data 122b, may be used together or separately to aid the driver 30 and/or vehicle 100, 100a (autonomous driving) to make intelligent decisions when maneuvering the vehicle 100, 100a. The sensor system 120 may include one or more cameras, an IMU (inertial measurement unit) configured to measure a linear acceleration (using one or more accelerometers) of the vehicle 100, 100a and a rotational rate (using one or more gyroscopes) of the vehicle 100, 100a, radar, sonar, LIDAR (Light Detection and Ranging, which may include optical remote sensing that measures properties of scattered light to find range and/or other information of a distant target), LADAR (Laser Detection and Ranging), and ultrasonic sensors. The sensor system 120 may also include other sensors.

The vehicle 100 may include a user interface 130. The user interface 130 may include a display 132, a knob, and a button, which are used as input mechanisms. The user interface 130 may also include a haptic device 134 to notify and alert the driver 30 or to provide guidance. The haptic device 134, may include, but is not limited to, a haptic accelerator, a haptic brake pedal, or a haptic steering wheel that may vibrate based on a triggered condition (e.g., energy inefficient driving or aggressive driving). In some examples, the display 132 may show the knob and the button. While in other examples, the knob and the button are a mechanical knob button combination. In some examples, the user interface 130 receives one or more driver commands from the driver 30 via one or more input mechanisms or the touch screen display 132 and/or displays one or more notifications to the driver 30. In some examples, the driver 30 may select an energy economic mode of driving versus a sport driving mode. The driver may also adjust a level of driving guidance (e.g., provided by a controller 200).

The vehicle 100, 100a also includes a propulsion system 140 that includes a source of mechanical power, i.e., engine or electric motor(s), and a mechanism that transfers this power to tractive force, i.e., transmission, wheels and axles. The propulsion system drives the vehicle 100, 100a in a forward/rearward direction. The propulsion system 140 varies based on the vehicle type, for example, the propulsion system 140 may include, but is not limited to, combustion propulsion, fuel cell propulsion, diesel propulsion, electric propulsion, hybrid propulsion (e.g., combustion engine and electric) or any other kind of propulsion system.

The vehicle also includes a controller 200 in communication with the vehicle control system 110, the sensor system 120, and the user interface 130. The controller 200 includes a computing device (processor or processing hardware) 202 (e.g., central processing unit having one or more computing processors) in communication with non-transitory memory 204 (e.g., a hard disk, flash memory, random-access memory, memory hardware) capable of storing instructions executable on the computing processor(s) 202. In some examples, the hardware processor 202 is configured to execute artificial intelligence (AI) algorithms. As such, the processor 202 receives multiple inputs and takes actions that maximize its change of achieving a specific defined goal; in other words, the processor 202 is configured to mimic cognitive functions that humans associate with other human minds, such as learning and problem solving. The processor 202 is capable of processing large data, that include, but is not limited to vehicle control system data 111, sensor data 122, and other data. The artificial intelligence algorithms may execute one of several learning methods, that include, but are not limited to, deep learning using neural networks, machine learning algorithms such as K-means clustering or regression learning (e.g. driving behavior index), or reinforcement learning algorithms using a performance reward goal (e.g., reward may be energy efficiency or vehicle performance).

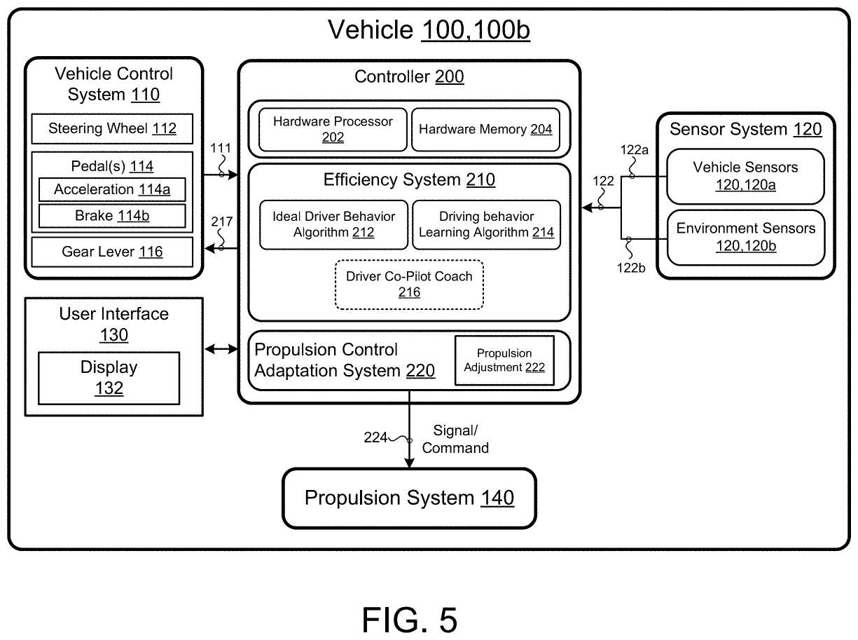

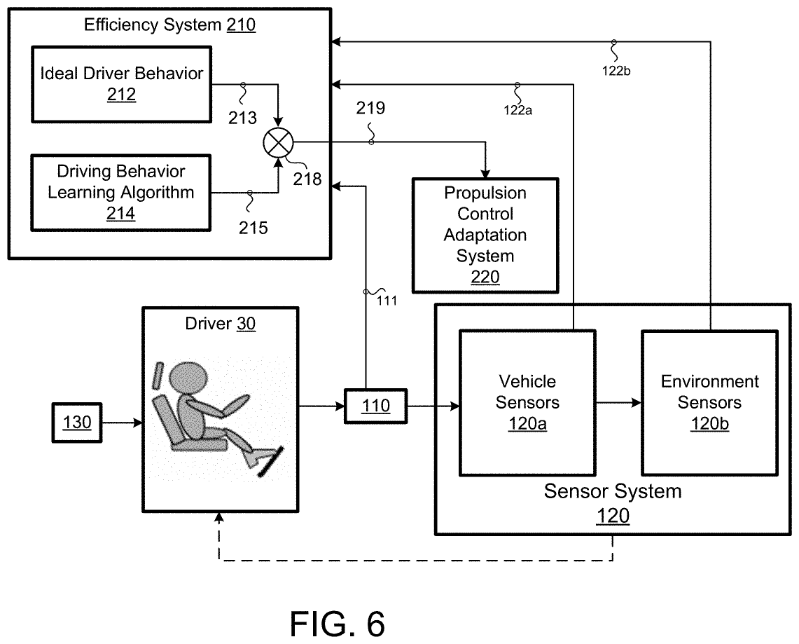

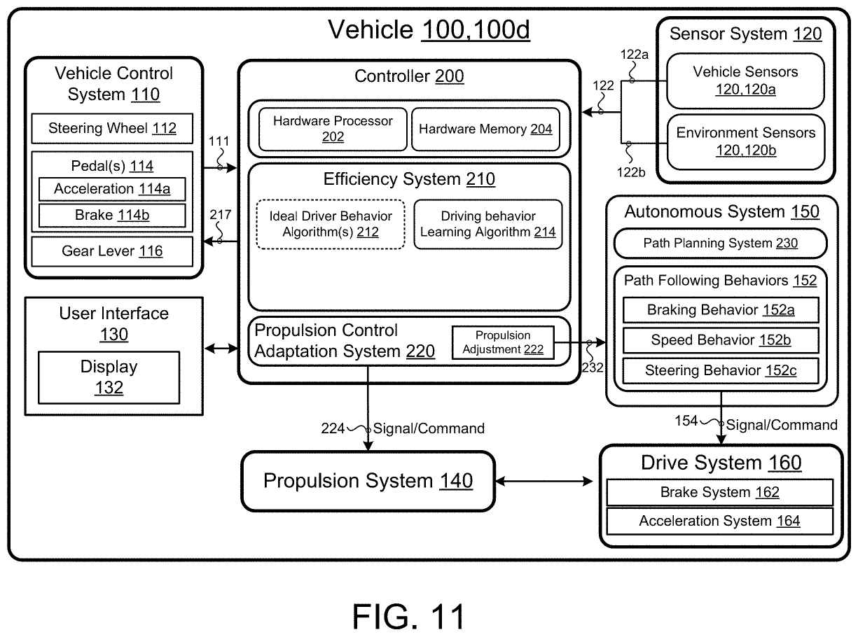

The controller 200, i.e., the processor 202, executes an efficiency system 210 that receives data from one or more systems, i.e., the vehicle control system 110 and the sensor system 120, and analyzes the received data to provide an anticipatory action. In some examples, the anticipatory action includes, but is not limited to, an indication to the driver 30 (e.g., by way of the display 132 and/or vibration of the haptic device 134 (e.g., vehicle 100a, FIGS. 2-4), a signal to the propulsion system 140 to adjust the propulsion of the vehicle (e.g., vehicle 100b, FIGS. 5-7), or a signal to the propulsion system 140 and an autonomous drive system 150 (e.g., vehicle 100d, FIGS. 11-14) to simultaneously adjust the vehicle propulsion and a driving behavior of the autonomous drive system 150 (e.g., vehicle 100d).

The efficiency system 210 includes an ideal driver behavior algorithm 212 that is either learned or stored in the hardware memory 204. The ideal driver behavior algorithm 212 determines an ideal driving action based on sensor data 122 and/or vehicle control system data 111 and maximizes the energy efficiency of the vehicle 100. Therefore, while the driver 30 is driving the vehicle 100, the ideal driver behavior algorithm 212 determines an ideal driving behavior/action given the current received sensor data 122 and/or vehicle control system data 111.

In some examples, the efficiency system 210 includes a driving behavior learning algorithm 214 that receives vehicle control data 111 (also referred to as direct driver input) from the vehicle control system 110, and vehicle sensor data 122a (also referred to as vehicle sensed observable or indirect driver input) from the vehicle sensors 120a, and environment sensor data 122b (also referred to as vehicle environment observable) from the environment sensors 120b. The driving behavior learning algorithm 214 learns the driving behavior of the driver 30 based on the received data 111, 122 over time. The driving behavior learning algorithm 214 correlates the driver driving actions in relation to propulsion efficiency of the propulsion system 140 and energy consumption of the vehicle 100. In addition, the driving behavior learning algorithm 214 stores the one or more driver driving actions as one or more stored driver behaviors 206 in memory 204, where each driver action is associated with specific direct driver inputs 111 and sensor data 122. In some examples, the driving behavior learning algorithm 214 may correlate driving behavior in relation to other parameter(s) to be optimized (i.e., a cost function). In some examples, the other parameter(s) may include, but is not limited to, fuel consumption, available driving range, driving travel time or any other vehicle parameter. The driving behavior learning algorithm 214 may identify the driver behavior as a class (e.g., aggressive, conservative, etc.) or associate with a behavior value or index within a range of values correlated with behaviors. The identified driver behavior 206 may also change in time and/or vehicle operating environment or scenario. The driving behavior learning algorithm 214 determines the driver behavior 206 continuously at a regular triggered internal (e.g., every 100 millisecond or 1 second). In some examples, the driving behavior learning algorithm 214 also correlates the driver behavior 206 to the vehicle environment (e.g., from environment sensor data from the environment sensors). In some implementations, the driving behavior learning algorithm 214 includes pre-learned training data (e.g., supervised learning) which helps the driving behavior learning algorithm 214 identify an aggressive driver behavior 206 or a conservative driver behavior 206. In other implementations, the driving behavior learning algorithm 214 determines the training data (e.g., unsupervised learning) and based on learning, identifies aggressive behaviors and conservative behaviors or a driving behavior value index in between multiple behavior classes.

As such, the driving behavior learning algorithm 214 may predict a driver action (e.g., a predicted driver behavior 215, e.g. wheel torque demand or desired vehicle acceleration, etc., given a set of data 111, 122 and the learned/saved driver behavior 206. In some examples, the driving behavior learning algorithm 214 monitors the driver behavior 206 of the driver for a period of time before the driving behavior learning algorithm 214 is able to determine a predicted driver behavior 215. In some implementations, during a learning phase, the driving behavior learning algorithm 214 receives direct driver inputs 111 (i.e., learning direct driver inputs) and sensor data 122 (i.e., learning sensor data). In addition, the driving behavior learning algorithm 214 may associate one or more driver actions with the learning direct driver inputs 111 and the learning sensor data 122. The one or more driver actions are indicative of an action taken by the driver 30 to control the vehicle 100 in response to the direct driver inputs 111 and the sensor data 122. Also during the learning phase, the driving behavior learning algorithm 214 may store the one or more driver actions as one or more stored predicted driver behaviors 206 in the memory hardware 204. Each driver action of the one or more driver actions is associated with the learning direct driver inputs 111 and the learning sensor data 122. In other words, the driving behavior learning algorithm 214 accumulates data that includes the direct driver inputs 111 and the sensor data 122 for a threshold of time before determining a predicted driver behavior 215 based on the received data 111, 122. Therefore during an implementation phase following the learning phase, the driving behavior learning algorithm 214 determines the predicted driver behavior 215 by retrieving, from the memory hardware 204, a stored learned driver behaviors 206 that is associated with direct driver inputs 111 and sensor data 122, where the direct driver inputs 111 and sensor data 122 similar to the received one or more direct driver inputs and the received sensor data respectively.

In some implementations, the efficiency system 210, i.e., the driving behavior learning algorithm 214 learns the driving behavior of the driver 30 and the behavior's correlations to vehicle propulsion efficiency. For example, the efficiency system 210 determines a base driver classification based on driver inputs 111 and some vehicle sensor inputs 122 (i.e., inputs of the accelerator pedal 114a and brake pedal 114b and longitudinal vehicle acceleration/deceleration) and behavior correlations to propulsion efficiency. Alternatively, the driving behavior learning algorithm 214 may include vehicle environment inputs 122b (e.g., road or driving route profile data) and driving use scenario influences with correlations to propulsion efficiency. In some examples, the driving behavior learning algorithm 214 may use other driver behavior learning approaches, which may include, but is not limited to, dynamic data such as traffic flow or surrounding vehicle data, vehicle following distances, weather conditions, traffic light data, etc. and driving behavior influence and correlation to propulsion efficiency. In some examples, the driving behavior learning algorithm 214 uses supervised learning approaches in which explicit training data sets of driving behavior inputs (i.e., accelerator brake pedal positions and rates of change and corresponding propulsion efficiency) may be used for learning. This is done offline then flashed in memory 204 into the controller 200. Many training data sets with additional inputs in addition to the driver inputs (pedal, steering, etc.) and vehicle sensor data (acceleration/deceleration, etc.) may be included for supervised learning. A neural network can be used to handle the multiple inputs and dimensions for learning. Unsupervised learning approaches may also be implemented in real-time for driver behavior learning, driver coaching and even propulsion control adjustment. For example, a reinforcement learning algorithm may be executed on processor 202 with a defined reward function such as maximizing energy efficiency, or any other vehicle performance target or optimization cost function. Using this approach does not need explicit training data sets, but rather the driving behavior and correlation to propulsion efficiency may be learned by iterative feedback based on achievement of the reward function. In this way, propulsion control adjustment 222 (as will be later discussed) and driver coaching for improved energy efficiency may be executed while driving. If the driver behavior maximized the reward (i.e., energy efficiency) that style of driving will be further encouraged via coaching. If the driving behavior minimizes the reward function, that style of driving will be discouraged. Similarly, the propulsion control adjustments will be adapted to achieve the desired reward (i.e., energy efficiency).

For each set of received data 111, 122, the ideal driver behavior algorithm 212 determines an ideal behavior 213 while the driving behavior learning algorithm 214 provides the predicted driver behavior 215 (of the driver 30) for the same set of received data 111, 122. A comparator 218 compares the ideal behavior 213 with the predicted (or learned) driver behavior 215 and determines a behavior difference 219. The behavior difference 219 may be considered as a driver deviation from the ideal driver behavior 213.

In some implementations, the efficiency system 210 includes a driver co-pilot coach 216 that receives the behavior difference 219 and provides a suggestion or coaching action to the driver 30 to improve the vehicle efficiency and reduce energy consumption. The vehicle efficiency may be fuel efficiency, electrical energy efficiency or other vehicle efficiencies. In some examples, the driver co-pilot coach 216 may instruct the user interface 130 to display a message on the display 132 that includes the suggestion or coaching action. For example, the message may state: “To improve vehicle efficiency, reduce your speed”, or “consider increasing the distance between you and the vehicle in front of you to increase your safety”, “consider moving to the left lane to maintain vehicle speed & efficiency.” The coaching action may be a vehicle speed target recommendation for achieving energy efficiency. The coaching action, in some examples, may be a suggestion to increase the vehicle speed to achieve higher vehicle efficiency. Additionally or alternatively, the driver co-pilot coach 216 may instruct the vehicle control system 110 to provide haptic feedback by way of the steering wheel 112, the pedals 114, and/or the gear lever 116. In some examples, the haptic feedback informs the driver 30 of an optimal or ideal driver behavior pedal position. For example, the driver co-pilot coach 216 may instruct the driver to initiate braking or tip out of the accelerator pedal by vibrating a haptic accelerator or brake pedal in the user interface 130. The driver co-pilot coach 216 may, additionally or alternatively, instruct a voice system (not shown) to provide an audible message or chime to the driver 30. Therefore, the driver co-pilot coach 216 coaches and trains the driver 30 to improve his driving by providing suggested anticipatory driving feedback while the driver 30 is driving. The driver co-pilot coach 216 continuously guides the driver 30 based on the behavior difference 219 to ultimately achieve ideal driver behavior 213 for energy efficiency or other performance driving criteria. In some examples, the co-pilot coach 210 dynamically coaches the driver 30, e.g., via the user interface 130 or the vehicle control system 110, to achieve an efficiency per unique “learned” behavior 215 and efficiency (guidance adjusted for driving scenario).

The efficiency system 210 (i.e., driving behavior learning algorithm 214) learns the driving behavior and patterns of a specific driver 30 and correlates the learned driving behaviors and patterns to the vehicle operating environment and external influence factors (i.e., based on the sensor data 122 from the sensor system 120). Then the efficiency system 210 (i.e., the driver co-pilot coach 216) dynamically coaches and provides suggestions to the driver 30 to adjust the way the driver 30 drives, thus achieving efficiency per learning. Based on the above, the efficiency system 210 associates one or more driver behaviors to the operation of the propulsion system 140 which leads to maximized efficiency or performance. In some examples, the driver co-pilot coach 216 dynamically coaches the driver 30 to achieve efficiency per learned recommendation, e.g., acceleration and de-acceleration profiling recommendations, optimal vehicle speed (V_{speed_optimal}). Therefore, the co-pilot coach 216 allows the driver 30 to improve his/her driving skills for maximizing vehicle energy efficiency by learning while driving.

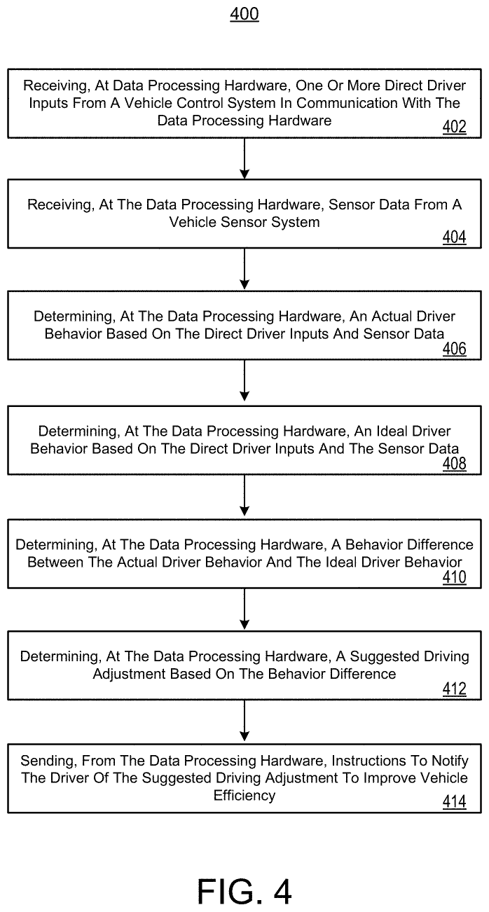

FIG. 4 provides an exemplary arrangement of operations for a method 400 of notifying a driver 30 of a suggested driving adjustment 216a in real time to improve vehicle efficiency and/or performance of a vehicle 100 described in FIGS. 2 and 3. At block 402, the method 400 includes receiving, at data processing hardware 202, one or more direct driver inputs 111 from a vehicle control system 110 in communication with the data processing hardware 202. The one or more direct driver inputs 111 may include inputs from a steering wheel 112, an acceleration pedal 114a, brake pedal 114b, and/or gear lever 116. At block 404, the method 400 includes receiving, at the data processing hardware 202, sensor data 122, 122a, 122b from a vehicle sensor system 120. In some examples, the sensor system 120 is in communication with the data processing hardware 202. The sensor data 122 may include vehicle sensor data 122a and/or environment sensor data 122b. The vehicle sensor data 122a may include data from at least one of battery sensors, traction drive motor sensors, engine sensors, brake system sensors, driveline component sensors, brake system sensors, and engine control system sensors. The vehicle sensor data 122a may include data from other sensors. In some examples, the environment sensor data 122b includes at least one of vehicle speed data, road speed limit data, route profile data, traffic light crossings data and their respective location data, weather conditions data, and dynamic traffic data. The environment sensor data 122b may include other sensor data. At block 406, the method 400 includes determining, at the data processing hardware 202, a predicted driver behavior 215 based on the direct driver inputs 111 and the sensor data 122. At block 408, the method 400 includes determining, at the data processing hardware 202, an ideal driver behavior 213 based on the direct driver inputs 111 and the sensor data 122. At block 410, the method 400 includes determining, at the data processing hardware 202 (e.g. a comparator 218), a behavior difference 219 between the predicted driver behavior 215 and the ideal driver behavior 213. At block 412, the method 400 includes determining, at the data processing hardware 202 (e.g., a driver co-pilot coach 216), a suggested driving adjustment 216a based on the behavior difference 219. At block 414, the method 400 includes sending, from the data processing hardware 202 (e.g., the driver co-pilot coach 216), instructions 217 to notify the driver 30 of the suggested driving adjustment 216a to improve vehicle efficiency (e.g., vehicle energy efficiency) and/or vehicle performance.

In some implementations, the instructions 217 include visual instructions 217a to a user interface 130 in communication with the data processing hardware 202. The visual instructions causing the user interface 130 to display a message that includes the suggested driving adjustment 216a. Additionally or alternatively, the instructions 217 may include feedback instructions 217b to the vehicle control system 110 in communication with the data processing hardware 202. The feedback instructions 217b causing the vehicle control system 110 to provide haptic feedback to the driver 30. The vehicle control system 110 may include at least one of a steering wheel 112, a brake pedal 114b, an acceleration pedal 114a, and a gear lever 116.

In some examples, the instructions 217. 217a, 217b include audible instructions to a voice system (not shown) in communication with the data processing hardware. The audible instructions cause the voice system to output an audible message or a chime.

Referring to FIGS. 5-7, in some implementations, a vehicle 100, 100b, similar to the vehicle 100, 100a previously described with reference to FIGS. 2 and 3, additionally includes a propulsion control adaptation system 220 that dynamically adapts the propulsion system 140 in anticipation of the driver action (i.e., the predicted driver behavior 215) based on the received data 111, 122. The propulsion control adaptation system 220 considers the mechanics and limitations of the propulsion system 140, for example, degrees of freedom (e.g., hybrid power split, transmission gear shifting (or ratio control), electric vehicle front/rear axle propulsion split, thermal setpoint, traction motor inverter operating point, engine cylinder firing or deactivation, etc.). As shown, the propulsion control adaption system 220 is part of the controller 200; however, the propulsion control adaptation system 220 may be a standalone system. The propulsion control adaptation system 220 determines a propulsion adjustment 222 and sends the propulsion system 140 instructions 224 including the propulsion adjustment 222 causing the propulsion system 140 to change its propulsion based on the propulsion adjustment 222. In some examples, the propulsion control adaptation system 220 receives the behavior difference 219 between the predicted driver behavior 215 and the ideal behavior 213 associated with current data 111, 122 and, based on the behavior difference 219, the propulsion control adaptation system 220 determines the propulsion adjustment 222 to the propulsion system 140. The propulsion adjustment 222 causes the propulsion system 140 to adjust one or more of its parameters in anticipation of a driver action, i.e., the predicted driver behavior 215. The driver action may be, but is not limited to, total wheel torque demand or tractive force demand per wheel, accelerator and brake pedal absolute positions or rate of change, steering inputs and/or frequency of steering angle changes, vehicle following distances to other vehicles, magnitudes of vehicle longitudinal or lateral accelerations or decelerations, time gaps between accelerator and brake pedal application or frequency of pedal application, changes in driving behavior with traffic flow (e.g., close vehicle following which may cause inefficiency, frequent stop/relaunch) etc. The parameters of the propulsion system 140 may include, but are not limited to, propulsion power or wheel torque response profiling or delay, gear shifting, axle torque distribution from front to rear or vice-versa, engine torque response and/or engine speed operating point in the case of a hybrid, power split between electric propulsion and combustion engine propulsion or even the powertrain operating state in the case of a full or plug-in parallel hybrid electric vehicle (HEV). Other examples may include transmission gear ratio in the case of a continuously variable transmission or even the number of engine cylinders firing or deactivated with engine applications with cylinder deactivation capability. The propulsion changes may include level one and/or level two changes. Level one changes include dynamically adapting control of the propulsion system 140 to match uniquely learned driving behavior as shown in FIGS. 5-14, while level two changes include dynamically adapting control of the propulsion system 140 to match the vehicle environment/driving scenario as shown in FIGS. 5-14. For example, in driving scenarios with heavy traffic flow and low speed driving with frequent vehicle stop and go, the driver will be coached to accelerate and decelerate smoother (i.e. slower rate vs. faster pedal changes which cause energy inefficiency) to adapt to the vehicle environment & driving situation. Similarly, the propulsion control system will be adjusted to slow down the wheel torque response for energy conservation and may maximize more electric driving in the case of a hybrid versus frequent engine stop/start. In this way, the driver is coached to change driving behavior and the propulsion system control is adjusted based on the vehicle environment.

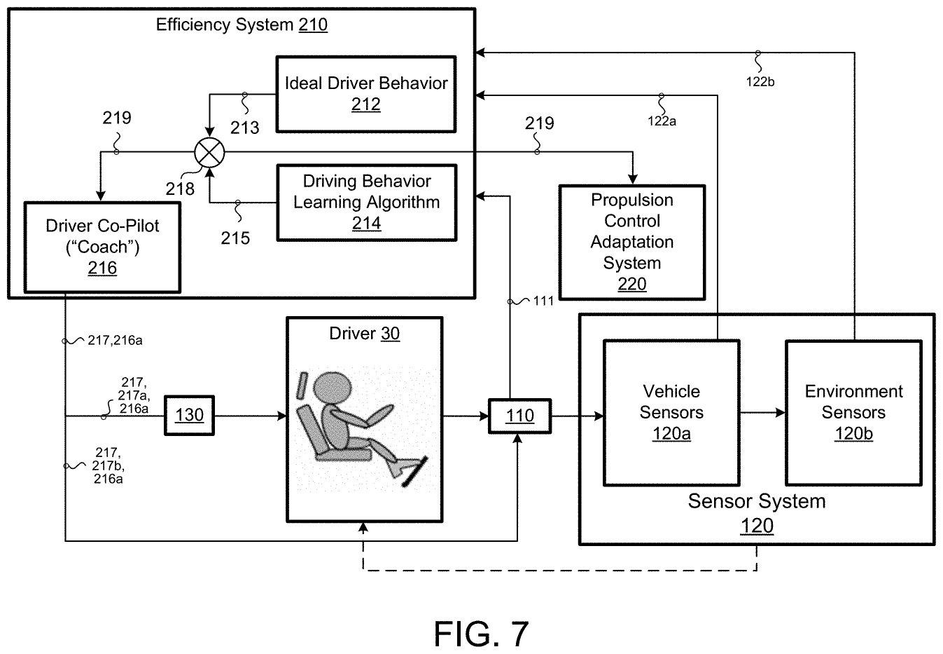

As shown in FIG. 7, the vehicle 100, 100b may also include a driver co-pilot coach 216 (similar to the co-pilot coach 216 previously described). However, in this case, the driver co-pilot coach 216 provides the driver 30 with information associated with the propulsion adjustment 222. In this way, both the driver 30 is coached for energy efficient driving and the propulsion system 220 is adapted to the driver's behavior. For examples, the driver co-pilot coach 216 may instruct the user interface 130 to display a message on the display 132 that includes the information associated with the propulsion adjustment 222. The message may include information associated with the change of the one or more parameters of the propulsion system 140 based on the propulsion adjustment 222.

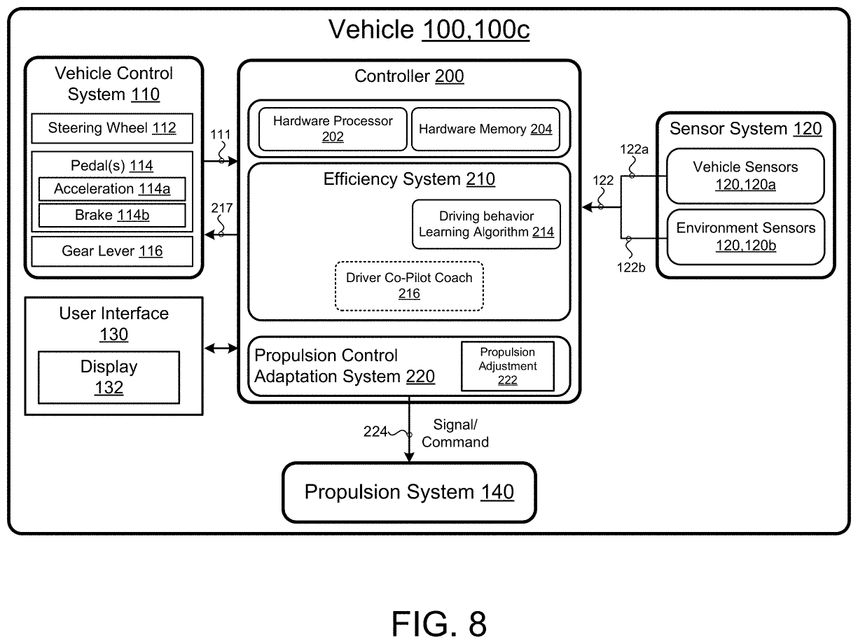

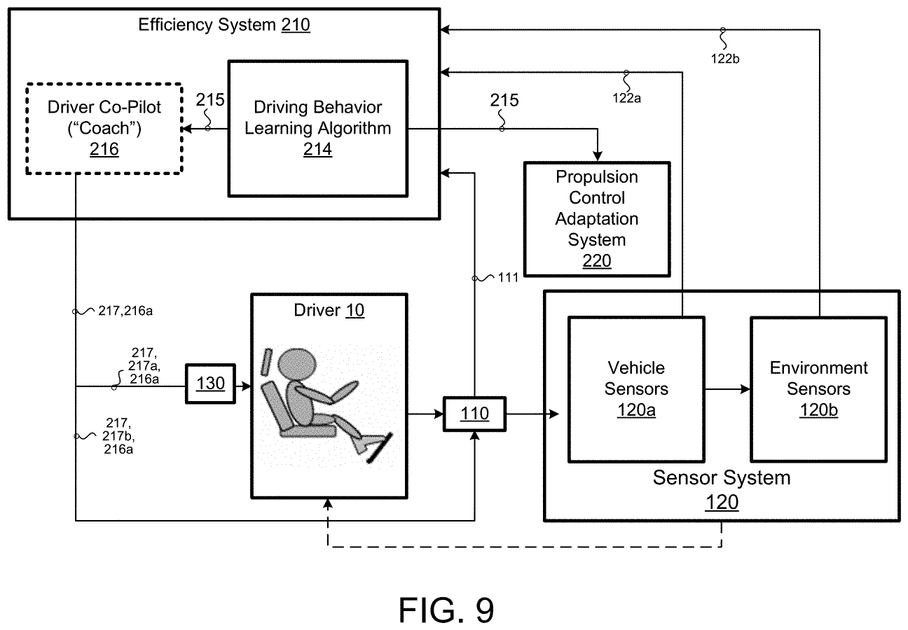

FIGS. 8 and 9 include a vehicle 100, 100c similar to the vehicle 100, 100b shown in FIGS. 5-7. However, the efficiency system 210 of the vehicle 100, 100c shown in FIGS. 8 and 9 (includes the driving behavior learning algorithm 214 without the ideal driver behavior algorithm 212. In this case, the propulsion control adaptation system 220 determines the propulsion adjustment 222 based on the predicted driver behavior 215. In other words, the propulsion adjustment 222 compares the current propulsion parameters of the propulsion system 140 and adjusts those parameters based on the predicted driver behavior 215. Since in this case, the efficiency system 210 is relying on only the driving behavior learning algorithm 214 and not an ideal driver behavior 213, then the propulsion adjustment 222 may not improve vehicle efficiency and/or performance, instead the propulsion adjustment 222 causes the parameters of the propulsion system 140 to adjust in anticipation of a driver action based on the predicted driver behavior 215.

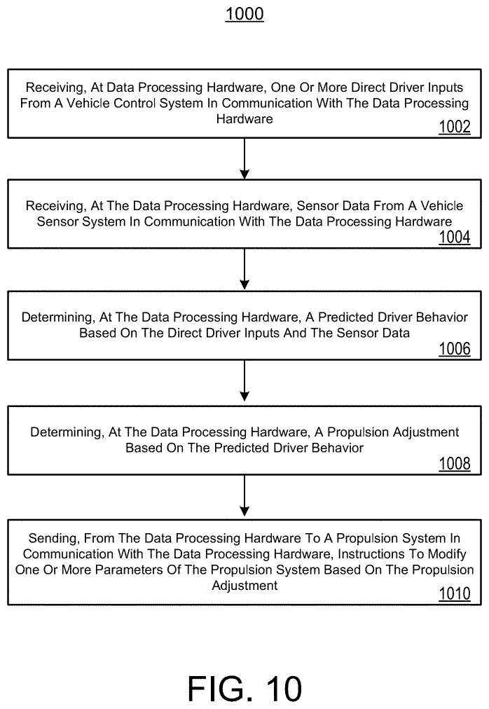

FIG. 10 provides an exemplary arrangement of operations for a method 1000 of controlling the propulsion system 140 of the vehicle 100, 100b, 100d in real time to improve vehicle efficiency and/or performance as shown in FIGS. 5-7 or to or to adjust the propulsion system 140 to accommodate a predicted driver behavior 215 of the vehicle 100, 100c, 100d as shown in FIGS. 8 and 9. At block 1002, the method 1000 includes receiving, at data processing hardware 202, one or more direct driver inputs 111 from a vehicle control system 110 in communication with the data processing hardware 202. The vehicle control system 110 may include, at least one of a steering wheel 112, an acceleration pedal 114a, a brake pedal 114b, and a gear lever 116. At block 1004, the method 1000 includes receiving, at the data processing hardware 202, sensor data (e.g., vehicle sensor data 122a and/or environmental sensor data 122b) from the vehicle sensor system 120 in communication with the data processing hardware 202. At block 1006, the method 1000 includes determining, at the data processing hardware 202, a predicted driver behavior 215 based on the direct driver inputs 111 and the sensor data 122. The predicted driver behavior 215 is previously learned during the learning phase as previously described. In addition, at block 1008, the method 1000 includes determining, at the data processing hardware 202, a propulsion adjustment 222 based on the predicted driver behavior 215. At block 1010, the method 1000 includes sending, from the data processing hardware 202 to a propulsion system 140 in communication with the data processing hardware 202, instructions 224 to modify one or more parameters of the propulsion system 140 based on the propulsion adjustment 222.

With reference to FIGS. 5-7, in some examples, the method 1000 includes determining an ideal driver behavior 213 based on the direct driver inputs 111 and the sensor data 122. In this case, the propulsion adjustment 222 is based on a difference between the predicted driver behavior 215 and the ideal driver behavior 213. The difference is determined by a comparator 218.

In some implementations, as shown in FIGS. 7 and 9, the method 1000 also includes sending visual instructions to a user interface 130 in communication with the data processing hardware 202. The visual instructions cause the user interface 130, i.e., the display 132, to display a message that includes the modification of the one or more parameters of the propulsion system 140. Additionally or alternatively, the method 1000 may include sending audible instructions to a voice system (not shown) in communication with the data processing hardware 202. The audible instructions cause the voice system to output an audible message or a chime indicative of the modification of the one or more parameters of the propulsion system 140.

Referring to FIGS. 11-13, in some implementations, the vehicle 100, 100d additionally includes an autonomous system 150 allowing the driver 30 to select an autonomous mode which causes the vehicle 100, 100d to autonomously drive along a path determined based on a destination selected by the driver 30. The autonomous system 150 may be in communication with the controller 200 as shown, or the autonomous system 150 may be part of the controller 200. The vehicle 100, 100d also includes a drive system 160 in communication with the autonomous system 150. The autonomous system 150 executes path following behaviors 152, 152a-152c to follow a path based on a driver selected destination. The path following behaviors 152, 152a-152c are executed by the drive system 160 and cause the vehicle 100, 100d to autonomously drive along the path. The autonomous system 150 receives a planned path based on a driver entered destination from a path planning system 230 of the controller 200. The autonomous system 150 executes the behaviors 152 without considering improving or maximizing the vehicle efficiency. However, since the efficiency system 210 determines a propulsion adjustment 222, then the autonomous system 150 considers the propulsion adjustment 222 when executing the behaviors 152 to improve autonomous driving efficiency. Additionally, the autonomous system 150 adjusts its behaviors 152 over time by learning from the propulsion adjustment 222 associated with sensor data 111, 122. In other words, the autonomous system 150 adjusts its autonomous driving behaviors 152 to imitate the ideal driver behavior 213 which improves the vehicle efficiency.

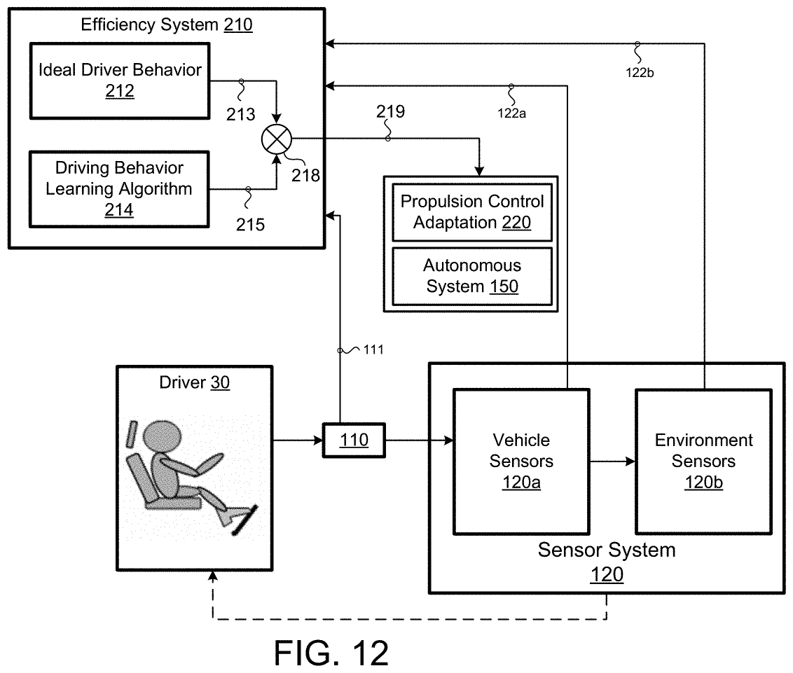

Referring to FIGS. 11 and 12, in some implementations, during the autonomous driving mode, the propulsion system 140 adjusts its parameters based on the learned ideal driver behavior 213 for vehicle acceleration and braking and steering behaviors, since it maximizes the energy efficiency of the vehicle 100d. This includes all learned ideal driver behavior 213 for various vehicle driving scenarios and vehicle environment efficiency learning. For example, the path following behavior 152 may accelerate the vehicle 100d at a reduced rate to maximize efficiency and minimize braking to conserve energy. The behavior may be altered based on the surrounding vehicle environment or driving scenario. For example, the path following behaviors 152 may increase vehicle following distances to vehicle in front to minimize frequent acceleration and deceleration in order to maintain near constant vehicle speed which maximizes energy efficiency. Therefore, during the autonomous mode of driving, the autonomous system 150 determines the driving behavior(s) 152 that causes the vehicle 100d to follow the path while taking into consideration sensors from the sensor system 120, while the efficiency system 210 improves the vehicle driving efficiency. In some examples, the vehicle 100d is a hybrid electric vehicle; the efficiency system may extend the electric driving distance of the vehicle 100d by improving its autonomous driving efficiency. In another example, the efficiency system 210 may extend vehicle coasting by disconnecting the driveline to minimize friction losses which would lead to unnecessary vehicle deceleration. Further examples of propulsion control adjustments 222 during autonomous driving may include changes in the transmission gear shift scheduling to minimize gear changes and operating in higher (lower ratio) gears to minimize engine braking and allow for reduced engine operating speeds. Additional examples of propulsion control adjustment include modifying torque control transient response performance to improve efficiency (e.g. air path only control on an engine versus use of spark retard, etc.). The propulsion control adjustments 222 applied may not be driven by deviations from undesirable driving behavior since autonomous driving is active. The adjustments are directly applied because the autonomous driving mode is active. In this way both ideal driving behavior (learned for optimizing efficiency and reduced energy consumption) is combined with a unique adapted propulsion system operation during autonomous driving. Further examples include but are not limited to, modifications to propulsion operating modes, engine cylinder deactivation scheduling, electric torque assist in the case of a mild hybrid, etc.

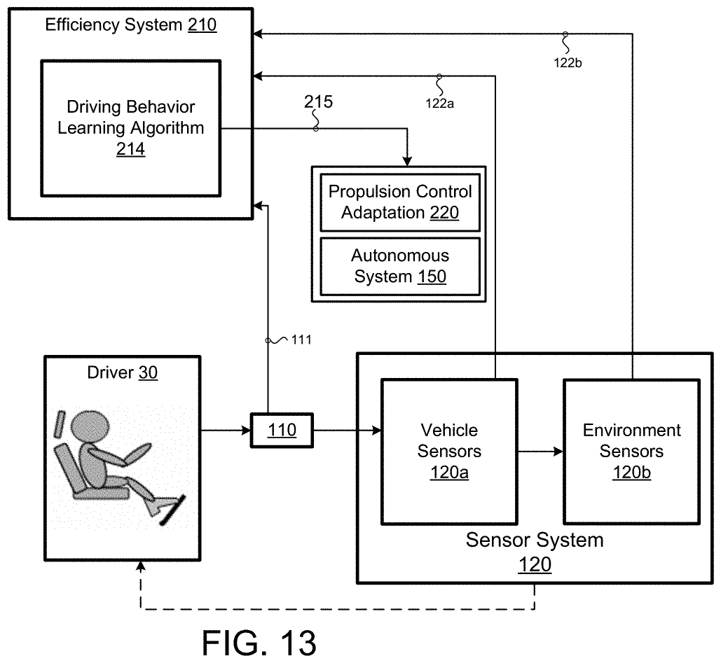

Referring to FIG. 13, in some implementations, during the autonomous mode, the driver 30 selects a driver autonomous mode which causes the vehicle 100d to drive in a manner similar to the driver 30. In this case, the autonomous system 150 adjusts its driving behavior based on the learned driver behavior 215. In addition, the autonomous vehicle 100d adjusts its propulsion system 140 based on an expected behavior from the driver 30. Although this mode does not result in an efficient driving, it allows the autonomous vehicle 100d to behave similar to a driver during driving.

The path following behaviors 152 may include a braking behavior 152a, a speed behavior 152b, and a steering behavior 152c. Other behaviors 152 may also be included. Each behavior 152a-152c causes the vehicle 100d to take an action, such as driving forward, turning at a specific angle, breaking, speeding, slowing down, among others. The vehicle controller 200 may maneuver the vehicle 100 in any direction across the road surface by controlling the drive system 160, more specifically by issuing commands 154 to a drive system 160.

Referring back to FIGS. 11-13, the vehicle 100, 100d may include the drive system 160 that maneuvers the vehicle 100 across a road surface based on drive commands having x, y, and z components, for example. The drive system 160 includes a front right wheel, a front left wheel, a rear right wheel, and a rear left wheel. The drive system 160 may include other wheel configurations as well. The drive system 160 may also include a brake system 162 that includes brakes associated with each wheel. The propulsion system 140 is in communication with the drive system 160. The propulsion system 140 controls longitudinal acceleration and deceleration of the vehicle 100. In addition, the brake system 162 also controls the deceleration of the vehicle 100.

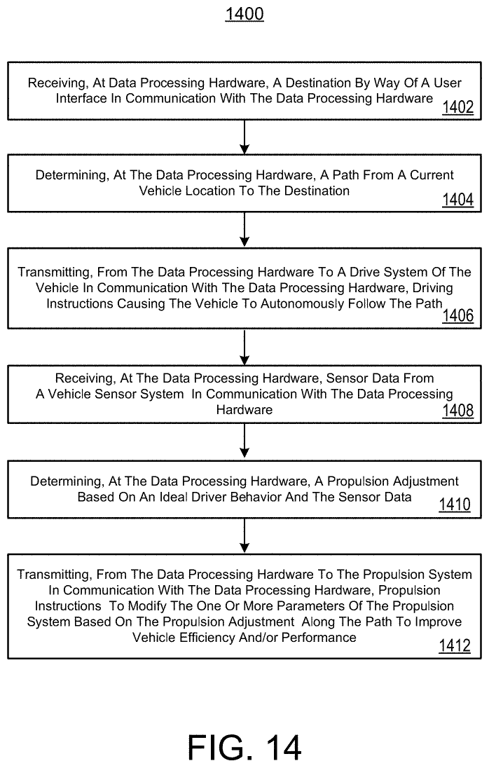

FIG. 14 provides an exemplary arrangement of operations for a method 1400 of modifying one or more parameters of a propulsion system 140 of a vehicle 100d in real time during an autonomous driving mode of the vehicle 100d. At block 1402, the method 1400 includes receiving, at data processing hardware 202, a destination by way of a user interface 130 in communication with the data processing hardware 202. At block 1404, the method 1400 includes determining, at the data processing hardware 202, a path from a current vehicle location to the destination. At block 1406, the method 1400 includes transmitting, from the data processing hardware 202 to a drive system of the vehicle 100d in communication with the data processing hardware 202, driving instructions causing the vehicle to autonomously follow the path. At block 1408, the method 1400 includes receiving, at the data processing hardware 202, sensor data 122, 122a, 122b from a vehicle sensor system 120 in communication with the data processing hardware 202. The sensor data 122, 122a, 122b includes vehicle sensor data 122a and environment sensor data 122b. The vehicle sensor data 122a includes at least one of battery sensor data, traction drive motor sensor data, and driveline component sensor data; while the environment sensor data 122b includes at least one of vehicle speed data, road speed limit data, route profile data, traffic light crossings data and their respective location data, weather conditions data, and dynamic traffic data.

Additionally, at block 1410, the method 1400 includes determining, at the data processing hardware 202, a propulsion adjustment 222 based on an ideal driver behavior 213 and the sensor data 122, 122a, 122b. At block 1412, the method 1400 includes transmitting, from the data processing hardware 202 to the propulsion system 140 in communication with the data processing hardware 202, propulsion instructions 224 to modify the one or more parameters of the propulsion system 140 based on the propulsion adjustment 222 along the path to improve vehicle efficiency and/or performance.

In some implementations, during a learning phase, the method 1400 includes receiving learning direct driver inputs 111 from a vehicle control system 110 in communication with the data processing hardware 202 and receiving learning sensor data 122, 122a, 122b from the vehicle sensor system 120. The vehicle control system 110 includes at least one of a steering wheel 112, a brake pedal 114a, an acceleration pedal 114b, and a gear lever 116. During the learning phase, the method 1400 also includes associating one or more ideal driver actions with the learning direct driver inputs 111 and the learning sensor data 122, 122a, 122b. The one or more ideal driver actions indicative of an action taken by an ideal driver to control the vehicle in response to the learning direct driver inputs 111 and the learning sensor data 122, 122a, 122b resulting in an improved efficiency and/or performance of the vehicle. During the learning phase, the method also includes storing the one or more associated ideal driver actions with the learning direct driver inputs 111 and the learning sensor data 122, 122a, 122b as one or more stored ideal driver behaviors 206 in memory hardware 204.

The method 1400 may also include determining the ideal driver behavior 213 by: retrieving, from the memory hardware 204 in communication with the data processing hardware 202, the ideal driver behavior 213 from the one or more stored ideal driver behaviors 206. The stored ideal driver behavior 213 associated with learning direct driver inputs 111 and learning sensor data 122, 122a, 122b being similar to the received one or more direct driver inputs 111 and the received sensor data 122, 122a, 122b respectively.

Table 1 below includes driving behavior learning levels 1-5 that may be implemented by the ideal driver behavior algorithm 212 and/or the driving behavior learning algorithm 214 during the learning phase as previously described. For examples, the ideal driver behavior algorithm 212 and/or driving behavior learning algorithm 214 implement the learning phase by executing each one of the described levels, i.e., levels 1 through level 5.

TABLE 1

| Learning Level | Driving Behavior Learned |
|---|---|
| Level 1, DB1 | Base Driving Behavior |
| Level 2, DB2 | DB1 + Vehicle Use/Cycle |
| Level 3, DB3 | DB1 + Vehicle Use/Cycle (Optional) + Road + |
| | Road Environment |
| Level 4, DB4 | DB3 + Vehicle Sensor Data |
| Level 5, DB5 | DB3 + Dynamic Vehicle Environment |

At level 1 DB1, the behavior learning algorithm 212, 214 learns the driving behavior of an ideal driver or the driver 30 without considering external factors and only direct driver inputs 111 and limited sensor data 122. At level 1 DB1 learning, the objective of the driving behavior learning algorithm 214 is to learn the base driving behavior of the driver 30; while the learning objective of the ideal driver behavior 213 is also base driving behavior and correlation of the driving behaviors to energy efficiency, which may be learned using accelerator, brake pedal inputs and longitudinal vehicle acceleration and deceleration and lateral accelerations. As previously mentioned, in some examples, the behavior learning algorithm 214 may associate a classification or a factor of the type of driving behaviors (e.g., aggressive, sport, economic, etc.). In some examples, if the behavior learning algorithm 212, 214 receives sensor data 122 indicative of high longitudinal and lateral accelerations with high rates of accelerator pedal changes, then the efficiency system 210 considers the driver 30 to be in the aggressive category. Similarly, if the behavior learning algorithm 212, 214 receives sensor data 122 indicative of low longitudinal and lateral accelerations and/or slow pedal rates, then the efficiency system 210 determines that the driver 30 is a conservative or economic driver 30. In some examples, the ideal driver behavior algorithm 212 correlates vehicle energy efficiency to each style of driving. For example, when the efficiency system 210 receives sensor data 120 indicative of high longitudinal acceleration and rapid accelerator pedal increases due to driver behavior, then the efficiency system 210 correlates such driver actions with energy inefficient driving. The driver co-pilot coach 216 may use the behaviors learned by the behavior learning algorithms 212, 214 to coach the driver 30 to drive in a smoother way (i.e., reduce longitudinal and lateral accelerations) which would gain vehicle efficiency. In some examples, one or more parameters of the propulsion system 140 are adjusted to filter out rapid changes in propulsion demand causing an increase of vehicle energy efficiency. During level 1 DB1, the behavior learning algorithms 212, 214 do not consider either the external effects for the driving scenario or dynamic conditions around the vehicle 100.

At level 2 DB2, the behavior learning algorithm 212, 214 considers the driving behavior of the driver 30 and a vehicle use (i.e., segmented use or cycle use). The behavior learning algorithm 212, 214 determines the driving behavior changes and/or unique driving patterns based on vehicle usage or specific driving scenarios. For example, if the vehicle 100 is used as a taxi or for utility with mainly low speed driving e.g., <60 kilometers/hour) but with frequent vehicle stops and launches, the driver 30 may be coached (by the driver co-pilot coach 216) to reduce vehicle accelerations to minimize energy losses or may be advised to increase vehicle following distances or even operate at reduced more constant vehicle speeds to maximize energy efficiency. In this case, the propulsion system 140 may be adjusted based on this vehicle usage scenario. For example, increased electric driving in the case of a hybrid vehicle may be implemented to minimize frequent engine stop/starts. The driving behavior learning algorithm 214 may also be implemented by segments of driving. For example, the behavior learning algorithm 212, 214 may learn behaviors only for vehicle launches from a stopped condition. Similarly, the behavior learning algorithm 212, 214 may learn an additional driving behavior for the segment of driving during vehicle deceleration or braking. This segmented learning may be used to advise the driver to decelerate longer to maximize energy efficiency or even brake faster to increase efficiency of regenerative braking and energy recovery in the case of an electric vehicle or hybrid application.

At level 3 DB3, the behavior learning algorithm 212, 214 may also consider the roads and the road environment, for example, from the information provided by a navigation system of the vehicle 100. At level 3 DB3, the driving behavior learning algorithm 214 and ideal driver behavior algorithm 212 may considers the effects of road grades, curvature, intersections, and surfaces on driving behavior. In some examples, the navigation system also provides driving path probability (DPP), time of day can also be used for learning. In this level of learning, the static vehicle driving environment may be correlated with the driving behavior. For example, if the road and driving route includes frequent changes in road curvature or grade, frequent acceleration and braking by the driver is expected. The driver co-pilot coach 216 may coach the driver to minimize rapid acceleration and braking in order to maintain a reduced near constant speed while driving on a curved road. Similarly, the propulsion system 140 may be adjusted to maximize energy recovery potential through regenerative braking if segments of downhill driving are on the route. In addition, the transmission shift schedule may be adjusted to minimize gear shifting and maintain a constant gear while driving through frequent changes in road curvature or grades. The driver will be coached to maintain more constant driving speeds to maximize energy efficiency.

At level 4 DB4, the behavior learning algorithm 212, 214 also considers the vehicle sensor system 120 that provides sensor data 122 including vehicle sensor data 122a and environmental sensor data 122b associated with a field-of-view of the driver 30 and surrounding the vehicle 100. For example, the sensor system 122, i.e., the vehicle sensors 122a may include front and/or rear short-range radars and/or cameras that are used to sense a number of surrounding vehicles and a distance to each one of the surrounding vehicles. As such, the ideal driver behavior algorithm 212 and driving behavior learning algorithm 214 may determine and learn the driver behavior based on a number of surrounding vehicles and the distances to immediate surrounding vehicles. The objective in this level of learning is to further correlate energy efficiency based on the driving behavior with immediate vehicle environment and vehicles. For example, if the driver follows too closely to immediate vehicles in front, frequent and unnecessary changes in the vehicle speed and accelerator and brake pedal inputs will be sensed which ultimately lead to inefficient driving since the driving behavior is determined to be aggressive. The energy losses would potentially increase if this occurs on a higher vehicle speed (i.e., freeway) versus city driving. The driving behavior learning algorithm 214 and ideal driver behavior algorithm 212 may learn the driver's behavior relating to vehicle following distances and speeds for optimized energy efficiency may be learned. Using this additional learning and information, the driver co-pilot coach 216 coaches the driver 30 to increase vehicle following distances which minimizes unnecessary accelerating and braking in addition to maintaining a near constant speed. This energy efficient style of driving would also be imitated and applied during piloted or autonomous driving to maximize energy efficiency. This level of driving behavior learning for immediate vehicle environment within the driver's field of view may be combined with the previous level of learning including information about the road and driving route. For example, if the driving route includes frequent changes in road curvature and grade, the driver may be advised to further increase vehicle following distances to minimize unnecessary changes in vehicle speed in order to increase energy efficiency.

At level 5 DB5, the behavior learning algorithm 212, 214 also considers dynamic vehicle environment information such as information from a telematics system of the vehicle 100. The telematics system may provide information that includes, but is not limited to, traffic information, weather information, light intersection information, and traffic light timing information. The behavior learning algorithm 212, 214 may include other learning levels. In some examples, the vehicle 100 may use the telematics information to increase or decrease the speed of the vehicle 100 during autonomous driving to reduce excessive vehicle stopping and launching using traffic light timing, causing the vehicle to conserve energy.

Table 2 below shows driver behavior classification and learned driver model measurable characteristics. In other words, the table shows measurable inputs that are considered by both the ideal driver behavior algorithm 212 and the behavior learning algorithm 214 when learning the driver behavior. Several factors influence the behavior learning algorithm 214 such as, but not limited to, three-dimensional map (slope/curve, crossing, etc.), traffic flow (traffic level and density, front and/or rear), road surface (weather), time of day, driver preview (distance and vision), and number of surrounding objects (in the field of view of the driver 30). As shown, some of the direct driver inputs 111 may include, but are not limited to, acceleration and brake pedal input velocities, steering input/angle deviations, and time gap between accelerator/brake pedal application and frequency. The sensor system 120 may receive sensor information that includes, but is not limited to, longitudinal vehicle acceleration and deceleration, average deviation from speed limit, and vehicle following distance (for example, at different vehicle speeds). Additionally, the sensor system 120 may also receive sensor information associated with a driver's focus. This sensor information may include, but is not limited to, steering input/angle deviations, and time gap between accelerator/brake pedal application, driver eyes monitoring (eyes on the road), average deviation from speed limit, and vehicle following distance (for example, at different vehicle speeds).

TABLE 2

| | | Vehicle | |
|---|---|---|---|
| | Direct | Observable | |
| | Driver | Driver | Driver |
| Measurable Driver Characteristics | Inputs | Effects | Focus |
| Accelerator/Brake pedal input | X | | |
| velocities | | | |
| Steering input/angle deviations | X | | X |
| Time gap between accelerator/brake | X | | X |
| pedal application (frequency) | | | |
| Driver eyes monitoring (eyes on road) | | | X |
| Longitudinal acceleration/deceleration | | X | |
| Lateral acceleration/deceleration | | X | |
| Average deviation from speed limit | | X | X |
| Vehicle Following Distance | | X | X |

Several factors may influence the measurable driver characteristics. These factors may include, but are not limited to, the three-dimensional map of the road, i.e., the slope/curvature, crossings, etc,), the traffic flow such as the level or density of the traffic, the road surface, the time of day, the driver preview distance/vision, and the number of surrounding objects for example in the driver's field of view.

Various implementations of the systems and techniques described here can be realized in digital electronic circuitry, integrated circuitry, specially designed ASICs (application specific integrated circuits), computer hardware, firmware, software, and/or

combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. A method of adjusting a propulsion system of a vehicle in real time, the method comprising:
receiving, at data processing hardware, one or more direct driver inputs from a vehicle control system in communication with the data processing hardware;
receiving, at the data processing hardware, sensor data from a vehicle sensor system in communication with the data processing hardware;
determining, at the data processing hardware, a predicted driver behavior based on the direct driver inputs and the sensor data;
determining, at the data processing hardware, a propulsion adjustment based on the predicted driver behavior; and
sending, from the data processing hardware to the propulsion system in communication with the data processing hardware, instructions to modify one or more parameters of the propulsion system based on the propulsion adjustment.

2. The method of claim 1, wherein the sensor data includes vehicle sensor data and environment sensor data.

3. The method of claim 2, wherein the vehicle sensor data includes at least one of battery sensor data, traction drive motor sensor data, and driveline component sensor data.

4. The method of claim 2, wherein the environment sensor data includes at least one of vehicle speed data, road speed limit data, route profile data, traffic light crossings data and their respective location data, weather conditions data, and dynamic traffic data.

5. The method of claim 1, further comprising:
determining an ideal driver behavior based on the direct driver inputs and the sensor data;
wherein the propulsion adjustment is based on a difference between the predicted driver behavior and the ideal driver behavior.

6. The method of claim 1, wherein the instructions include visual instructions to a user interface in communication with the data processing hardware, the visual instructions causing the user interface to display a message, the message including the modification of the one or more parameters of the propulsion system.

7. The method of claim 1, wherein the instructions include audible instructions to a voice system in communication with the data processing hardware, the audible instructions causing the voice system to output an audible message or a chime indicative of the modification of the one or more parameters of the propulsion system.

8. The method of claim 1, further comprising, during a learning phase:
receiving learning direct driver inputs from the vehicle control system;
receiving learning sensor data from the vehicle sensor system;
associating one or more driver actions with the learning direct driver inputs and the learning sensor data, the one or more driver actions indicative of an action taken by a driver of the vehicle to control the vehicle in response to the learning direct driver inputs and the learning sensor data;
storing the one or more associated driver actions with the learning direct driver inputs and the learning sensor data as one or more stored driver behaviors in memory hardware.

9. The method of claim 8, wherein determining the predicted driver behavior includes:
retrieving, from the memory hardware in communication with the data processing hardware, a stored driver behavior from the one or more stored driver behaviors, wherein the stored driver behavior associated with learning direct driver inputs and learning sensor data being similar to the received one or more direct driver inputs and the received sensor data respectively.

10. A system for adjusting a propulsion system of a vehicle in real time, the system comprising:
data processing hardware; and
memory hardware in communication with the data processing hardware, the memory hardware stores instructions that when executed on the data processing hardware cause the data processing hardware to perform operations comprising:
receiving one or more direct driver inputs from a vehicle control system in communication with the data processing hardware;
receiving sensor data from a vehicle sensor system in communication with the data processing hardware;
determining a predicted driver behavior based on the direct driver inputs and the sensor data;
determining a propulsion adjustment based on the predicted driver behavior; and
sending instructions to a propulsion system in communication with the data processing hardware to modify one or more parameters of the propulsion system based on the propulsion adjustment.

11. The system of claim 10, wherein the sensor data includes vehicle sensor data and environment sensor data.

12. The system of claim 11, wherein the vehicle sensor data includes at least one of battery sensor data, traction drive motor sensor data, and driveline component sensor data.

13. The system of claim 11, wherein the environment sensor data includes at least one of vehicle speed data, road speed limit data, route profile data, traffic light crossings data and their respective location data, weather conditions data, and dynamic traffic data.

14. The system of claim 10, wherein the operations further comprise:
determining an ideal driver behavior based on the direct driver inputs and the sensor data;
wherein the propulsion adjustment is based on a difference between the predicted driver behavior and the ideal driver behavior.

15. The system of claim 10, wherein the instructions include visual instructions to a user interface in communication with the data processing hardware, the visual instructions causing the user interface to display a message, the message including the modification of the one or more parameters of the propulsion system.

16. The system of claim 10, wherein the instructions include audible instructions to a voice system in communication with the data processing hardware, the audible instructions causing the voice system to output an audible message or a chime indicative of the modification of the one or more parameters of the propulsion system.

17. The system of claim 10, wherein during a learning phase, the operations further include:
receiving learning direct driver inputs from the vehicle control system;
receiving learning sensor data from the vehicle sensor system;
associating one or more driver actions with the learning direct driver inputs and the learning sensor data, the one or more driver actions indicative of an action taken by a driver of the vehicle to control the vehicle in response to the learning direct driver inputs and the learning sensor data;
storing the one or more associated driver actions with the learning direct driver inputs and the learning sensor data as one or more stored driver behaviors in memory hardware.

18. The system of claim 17, wherein determining the predicted driver behavior includes:
retrieving, from the memory hardware in communication with the data processing hardware, a stored driver behavior from the one or more stored driver behaviors, wherein the stored driver behavior associated with learning direct driver inputs and learning sensor data being similar to the received one or more direct driver inputs and the received sensor data respectively.
